(19) United States
(12) Patent Application Publication
(10) Pub. No.: US 2006/0204139 A1
(43) Pub. Date: Sep. 14, 2006

(54) Image processing device, image processing method, display controller, and electronic instrument

(75) Inventor: Tadashi Hayashi, Chofu-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/363,995

(22) Filed: Mar. 1, 2006

(30) Foreign Application Priority Data
Mar. 8, 2005 (JP) 2005-063492

(51) Int. Cl. G06K 9/32; H04N 1/393; G09G 5/00

(52) U.S. Cl. 382/298; 345/660; 358/451

(57) ABSTRACT

An image processing including: a scale factor setting register in which a reciprocal of a scale factor at which the input image is scaled up or scaled down is set; and a seamless pixel processing section which performs the scale-up or scale-down processing of an image based on the reciprocal of the scale factor. The seamless pixel processing section outputs pixel data of an image obtained by subjecting the input image to the scale-up processing when an integer part of the reciprocal of the scale factor is “0”, and outputs pixel data of an image obtained by subjecting the input image to the scale-down processing when the integer part of the reciprocal of the scale factor is not “0”.

Japanese Patent Application No. 2005-63492, filed on Mar. 8, 2005, is hereby incorporated by reference in its entirety.

### BACKGROUND OF THE INVENTION

The present invention relates to an image processing device, an image processing method, a display controller, and an electronic instrument.

In a portable electronic instrument (e.g. portable telephone) including a camera module, an image captured by the camera module can be displayed on a screen of an electro-optical device such as a liquid crystal display (LCD) panel. In this case, the size of the captured image is scaled up or scaled down taking into consideration the screen size of the electro-optical device or the capacity of a memory which stores data of the captured image.

For example, JP-A-9-326958 discloses an image processing device which scales up and scales down such an image. In this image processing device, the scale-up or scale-down factor of the image is calculated using the number of pixels of the image before processing as a divisor and the number of pixels of the image after processing as a dividend. An interpolation coefficient for linear interpolation of each pixel of the image after processing is calculated by accumulating the reciprocal of the resulting scale factor.

However, since the number of pixels of the image before and after processing is set in a related-art image processing device, a divider is required to calculate the reciprocal of the scale factor, whereby the circuit scale is increased.

In a related-art image processing device, it is necessary to compare the accumulation result of the reciprocal of the scale factor with a count value of a pixel counter. Therefore, the necessary number of bits used in the pixel counter is increased as the screen size of an electro-optical device is increased. Moreover, since the upper limit of the image size is fixed by the number of bits of the pixel counter, it may be impossible to deal with an increase in the screen size of an electro-optical device.

In a related-art image processing device, firmware (software) for controlling the image processing device must set an operation mode which designates scaling up or scaling down of an image in addition to the number of pixels of the image before and after processing. It is necessary for the firmware to also designate error processing when controlling such an image processing device so that the amount of code of the firmware is increased.

FIG. 18A shows an example of the code of firmware for controlling a related-art image processing device.

When it is necessary to set the operation mode which designates scaling up or scaling down in addition to a parameter which designates an input image, a parameter which designates an output image, and a scale factor, error processing must be provided in a flow which directs the image processing device to perform scale-up processing and a flow which directs the image processing device to perform scale-down processing. This increases the amount of code of the firmware.

On the other hand, when it is unnecessary to set the operation mode which designates scaling up or scaling down of an image in the image processing device, the amount of code of the firmware for controlling the image processing device can be significantly reduced.

FIG. 18B shows an example of the code of firmware for controlling an image processing device in which it is unnecessary to set the operation mode which designates scaling up or scaling down of an image.

In this case, since it suffices to set a parameter which designates an input image, a parameter which designates an output image, and a scale factor, it is unnecessary to provide error processing in each flow as shown in FIG. 18A. Therefore, the amount of code of the firmware can be reduced as shown in FIG. 18B.

As described above, it is desirable that an image processing device be able to seamlessly perform image scale-up and scale-down processing according to the set scale factor without the need to designate the operation mode each time the scale factor is changed.

### SUMMARY

According to a first aspect of the invention, there is provided an image processing device for performing scale-up and scale-down processing of an input image, the image processing device comprising:

a scale factor setting register in which a reciprocal of a scale factor at which the input image is scaled up or scaled down is set;

an accumulator which accumulates the reciprocal of the scale factor; and

a seamless pixel processing section which performs the scale-up or scale-down processing of an image based on an accumulation result of the accumulator, the seamless pixel processing section outputting pixel data of an image obtained by subjecting the input image to the scale-up processing when an integer part of the reciprocal of the scale factor is “0”, outputting pixel data of an image obtained by subjecting the input image to the scale-down processing when the integer part of the reciprocal of the scale factor is not “0”, and outputting a validation signal, which designates whether or not to thin out each pixel of the input image, during the scale-down processing, based on the accumulation result of the accumulator.

According to a second aspect of the invention, there is provided an image processing device for performing scale-up and scale-down processing of an input image, the image processing device comprising:

a scale factor setting register in which a reciprocal of a scale factor at which the input image is scaled up or scaled down is set; and

a seamless pixel processing section which performs the scale-up or scale-down processing of an image based on the reciprocal of the scale factor, the seamless pixel processing section outputting pixel data of an image obtained by subjecting the input image to the scale-up processing when an integer part of the reciprocal of the scale factor is “0”, and outputting pixel data of an image obtained by subjecting the input image to the scale-down processing when the integer part of the reciprocal of the scale factor is not “0”.

According to a third aspect of the invention, there is provided an image processing method for performing scale-up and scale-down processing of an input image, the method comprising:

setting a reciprocal of a scale factor at which the input image is scaled up or scaled down in a scale factor setting register;

outputting pixel data of an image obtained by subjecting the input image to the scale-up processing when the integer part of the reciprocal of the scale factor set in the scale factor setting register is “0”; and

outputting pixel data of an image obtained by subjecting the input image to the scale-down processing when the integer part of the reciprocal of the scale factor is not “0”.

According to a fourth aspect of the invention, there is provided a display controller comprising:

a pixel data input interface to which pixel data of an input image is input;

a first scaler circuit which performs scale-up or scale-down processing of the input image input through the pixel data input interface;

a frame buffer which stores data processed by the first scaler circuit;

a second scaler circuit which performs the scale-up or scale-down processing of an image expressed by pixel data read from the frame buffer; and

an output interface which performs interface processing for outputting data processed by the second scaler circuit,

at least one of the first and second scaler circuits including:

a horizontal direction image processing section which performs the scale-up or scale-down processing for pixel data of an image arranged in a horizontal direction; and

a vertical direction image processing section which performs the scale-up or scale-down processing for pixel data of the image arranged in a vertical direction; and

at least one of the horizontal direction image processing section and the vertical direction image processing section including any of the above-described image processing devices.

According to a fifth aspect of the invention, there is provided an electronic instrument comprising:

a display panel;

the above-described display controller; and

a display driver which drives the display panel based on pixel data supplied from the display controller.

### BRIEF DESCRIPTION OF THE SEVERAL VIEWS OF THE DRAWING

FIG. 1 is a block diagram of an outline of a configuration of an image processing device according to one embodiment of the invention.

FIG. 2 is a diagram showing an example of the relationship between processed pixel data and a validation signal.

FIG. 3 is a diagram illustrative of image scale-up and scale-down processing according to one embodiment of the invention.

FIG. 4 is a diagram illustrative of pixel data of an interpolated pixel.

FIG. 5 is a block diagram of a configuration example of an accumulator shown in FIG. 1.

FIG. 6 is a diagram illustrative of an integer part and a decimal fraction part of data set in a scale factor setting register.

FIG. 7 is a diagram schematically showing the operation of the accumulator shown in FIG. 5 in a scale-up processing mode.

FIG. 8 is a diagram schematically showing the operation of the accumulator shown in FIG. 5 in a scale-down processing mode.

FIG. 9 is a block diagram of a configuration example of a coefficient LUT shown in FIG. 1.

FIG. 10 is a block diagram of a configuration example of the accumulator, the coefficient LUT, and a filter calculation section shown in FIG 1.

FIG. 11 is a diagram illustrative of an example of scale-up processing of the image processing device according to one embodiment of the invention.

FIG. 12 is a diagram illustrative of an example of scale-down processing of the image processing device according to one embodiment of the invention.

FIG. 13 is a block diagram of a configuration example of a display controller to which the image processing device according to one embodiment of the invention is applied.

FIG. 14 is a block diagram of a configuration example of a first scaler circuit shown in FIG. 13.

FIG. 15 is a diagram showing the relationship among a pixel clock signal, a pixel validation signal, and pixel data.

FIG. 16 is a block diagram of a configuration example of a second scaler circuit shown in FIG. 13.

FIG. 17 is a block diagram of a configuration example of an electronic instrument according to one embodiment of the invention.

FIGS. 18A and 18B are diagrams illustrative of the code of firmware.

### DETAILED DESCRIPTION OF THE EMBODIMENT

The invention may provide an image processing device, an image processing method, a display controller, and an electronic instrument capable of reducing the circuit scale and performing image scale-up and scale-down processing according to the set scale factor without designating scaling up or scaling down.

According to one embodiment of the invention, there is provided an image processing device for performing scale-up and scale-down processing of an input image, the image processing device comprising:

a scale factor setting register in which a reciprocal of a scale factor at which the input image is scaled up or scaled down is set;

an accumulator which accumulates the reciprocal of the scale factor; and

a seamless pixel processing section which performs the scale-up or scale-down processing of an image based on an accumulation result of the accumulator, the seamless pixel processing section outputting pixel data of an image obtained by subjecting the input image to the scale-up processing when an integer part of the reciprocal of the scale factor is “0”, outputting pixel data of an image obtained by subjecting the input image to the scale-down processing when the integer part of the reciprocal of the scale factor is not “0”, and outputting a validation signal, which designates whether or not to thin out each pixel of the input image, during the scale-down processing, based on the accumulation result of the accumulator.

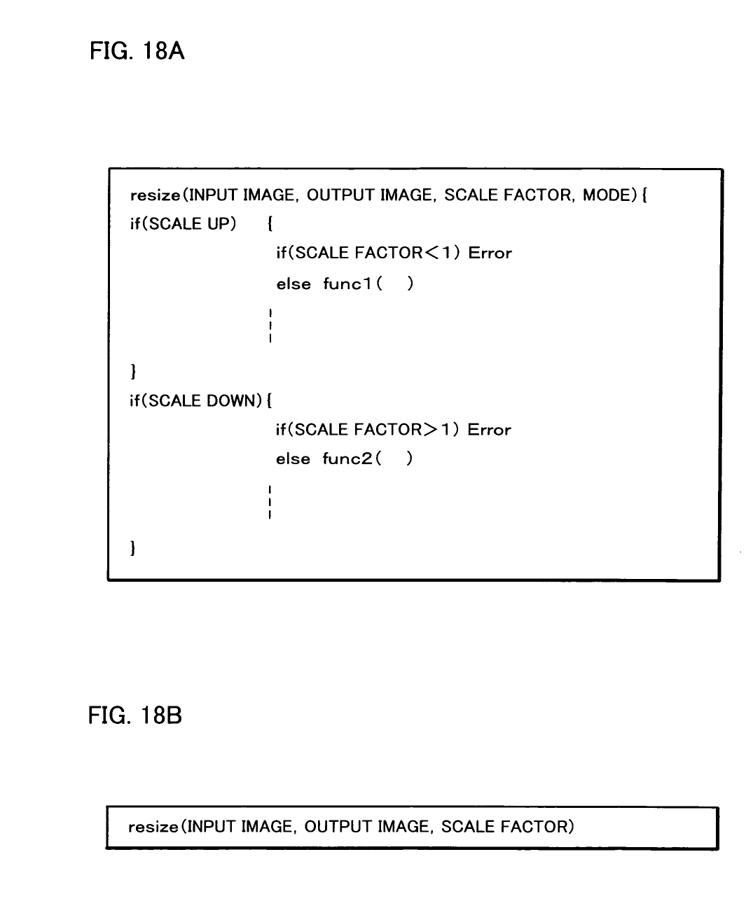

In this embodiment, since it is unnecessary to set the numbers of pixels of the image before and after processing in order to calculate the scale factor when performing the image scale-up and scale-down processing, a configuration in which a divider is omitted can be employed. Moreover, the image scale-up or scale-down processing can be performed based on the integer part of the reciprocal of the scale factor which is accumulated in order to perform the image scale-up or scale-down processing. Therefore, it is possible to seamlessly perform the image scale-up and scale-down processing according to the set scale factor without indicating scaling up or scaling down to the image processing device. This makes it possible to reduce the amount of code of firmware for controlling the image processing device as shown in FIG. 18B, for example.

Moreover, since the validation signal which indicates whether or not to thin out each pixel can be output in the scale-down processing, a device in the subsequent stage of the image processing device can easily thin out a pixel based on the validation signal. Since the image processing device calculates the pixel data after the scale-down processing and generates the validation signal, it is unnecessary to generate the validation signal using another means after calculating the pixel data after the scale-down processing.

In this image processing device,

the seamless pixel processing section may include a filter calculation section which performs product-sum calculation based on pixel data of the input image and an output from the accumulator to generates the pixel data after the scale-up or scale-down processing;

when the integer part of the reciprocal of the scale factor is “0” and an integer part of the accumulation result is not “0”, the seamless pixel processing section may update pixel data to be processed by the filter calculation section, and perform product-sum calculation of the updated pixel data and a coefficient corresponding to at least a part of a decimal fraction part of the accumulation result to generate the pixel data of the image after the scale-up processing;

when the integer part of the reciprocal of the scale factor is “0” and the integer part of the accumulation result is “0”, the seamless pixel processing section may perform product-sum calculation of pixel data updated previously and a coefficient corresponding to at least a part of the decimal fraction part of the accumulation result without updating pixel data to be processed by the filter calculation section to generate the pixel data of the image after the scale-up processing;

when the integer part of the reciprocal of the scale factor is not “0” and the integer part of the accumulation result is not “0”, the seamless pixel processing section may decrement the integer part of the accumulation result and may not update an output from the filter calculation section; and

wherein, when the integer part of the reciprocal of the scale factor is not “0” and the integer part of the accumulation result is “0”, the seamless pixel processing section may decrement an integer part of an addition result of the reciprocal of the scale factor and the output from the accumulator, and perform product-sum calculation of pixel data to be processed by the filter calculation section and a coefficient corresponding to at least a part of the decimal fraction part of the accumulation result to generate the pixel data of the image after the scale-down processing.

Since the image scale-up and scale-down processing based on the accumulation result of the reciprocal of the scale factor can be realized by using almost the same resource, it is possible to seamlessly perform the image scale-up and scale-down processing according to the set scale factor without designating scaling up or scaling down for the image processing device.

In this embodiment, it is unnecessary to compare the accumulation result of the reciprocal of the scale factor with a count value of a pixel counter. Therefore, a problem can be prevented in which the necessary number of bits used in the pixel counter is increased as the screen size of an electro-optical device is increased. Moreover, a problem can be prevented in which the upper limit of the image size is fixed by the number of bits of the pixel counter so that it is impossible to deal with an increase in the screen size of an electro-optical device.

According to one embodiment of the invention, there is provided an image processing device for performing scale-up and scale-down processing of an input image, the image processing device comprising:

a scale factor setting register in which a reciprocal of a scale factor at which the input image is scaled up or scaled down is set; and

a seamless pixel processing section which performs the scale-up or scale-down processing of an image based on the reciprocal of the scale factor, the seamless pixel processing section outputting pixel data of an image obtained by subjecting the input image to the scale-up processing when an integer part of the reciprocal of the scale factor is “0”, and outputting pixel data of an image obtained by subjecting the input image to the scale-down processing when the integer part of the reciprocal of the scale factor is not “0”.

In this embodiment, since it is unnecessary to set the number of pixels of the image before and after processing in order to perform the image scale-up and scale-down processing, a configuration in which a divider is omitted can be employed. Moreover, the image scale-up or scale-down processing can be performed based on the integer part of the reciprocal of the scale factor which is accumulated in order to perform the image scale-up or scale-down processing. Therefore, it is possible to seamlessly perform the image scale-up and scale-down processing according to the set scale factor without indicating scaling up or scaling down to the image processing device. This makes it possible to reduce the amount of code of firmware for controlling the image processing device as shown in FIG. 18B, for example.

According to one embodiment of the invention, there is provided an image processing method for performing scale-up and scale-down processing of an input image, the method comprising:

setting a reciprocal of a scale factor at which the input image is scaled up or scaled down in a scale factor setting register;

outputting pixel data of an image obtained by subjecting the input image to the scale-up processing when the integer part of the reciprocal of the scale factor set in the scale factor setting register is “0”; and

outputting pixel data of an image obtained by subjecting the input image to the scale-down processing when the integer part of the reciprocal of the scale factor is not “0”.

The image processing method may comprise:

accumulating the reciprocal of the scale factor; and

designating whether or not to thin out each pixel of the input image, during the scale-down processing, based on an accumulation result of the reciprocal of the scale factor.

In this image processing method,

when the integer part of the reciprocal of the scale factor is “0” and an integer part of the accumulation result is not “0”, processing target pixel data may be updated, and product-sum calculation of the updated pixel data and a coefficient corresponding to at least a part of a decimal fraction part of the accumulation result may be performed to generate the pixel data of the image after the scale-up processing;

when the integer part of the reciprocal of the scale factor is “0” and the integer part of the accumulation result is “0”, product-sum calculation of pixel data updated previously and a coefficient corresponding to at least a part of the decimal fraction part of the accumulation result may be performed without updating processing target pixel data to generate the pixel data of the image after the scale-up processing;

when the integer part of the reciprocal of the scale factor is not “0” and the integer part of the accumulation result is not “0”, the accumulation result may be decremented; and

when the integer part of the reciprocal of the scale factor is not “0” and the integer part of the accumulation result is “0”, a value obtained by decrementing the reciprocal of the scale factor may be added to the accumulation result, and product-sum calculation of processing target pixel data and a coefficient corresponding to at least a part of the decimal fraction part of the accumulation result may be performed to generate the pixel data after the scale-down processing.

According to one embodiment of the invention, there is provided a display controller comprising:

a pixel data input interface to which pixel data of an input image is input;

a first scaler circuit which performs scale-up or scale-down processing of the input image input through the pixel data input interface;

a frame buffer which stores data processed by the first scaler circuit;

a second scaler circuit which performs the scale-up or scale-down processing of an image expressed by pixel data read from the frame buffer; and

an output interface which performs interface processing for outputting data processed by the second scaler circuit,

at least one of the first and second scaler circuits including:

a horizontal direction image processing section which performs the scale-up or scale-down processing for pixel data of an image arranged in a horizontal direction; and

a vertical direction image processing section which performs the scale-up or scale-down processing for pixel data of the image arranged in a vertical direction; and

at least one of the horizontal direction image processing section and the vertical direction image processing section including any of the above-described image processing devices.

According to one embodiment of the invention, there is provided an electronic instrument comprising:

a display panel;

the above-described display controller; and

a display driver which drives the display panel based on pixel data supplied from the display controller.

In this embodiment, an electronic instrument capable of reducing the circuit scale and displaying an image subjected to the scale-up or scale-down processing according to the set scale factor without designating scaling up or scaling down can be provided.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Image Processing Device

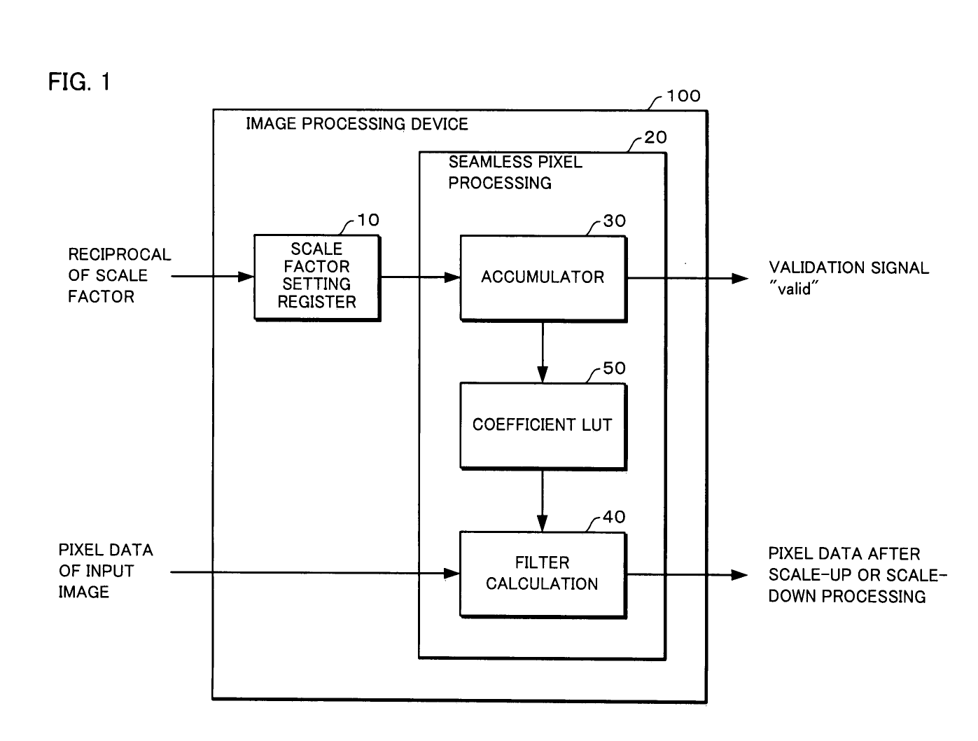

FIG. 1 is a block diagram showing an outline of a configuration of an image processing device according to one embodiment of the invention.

An image processing device 100 performs image scale-up (zoom) and scale-down (shrink) processing for pixel data of an input image. In more detail, the image processing device 100 includes a scale factor setting register 10 and a seamless pixel processing section 20. The reciprocal of the scale factor at which an input image is scaled up or scaled down is set in the scale factor setting register 10. The seamless pixel processing section 20 performs scale-up or scale-down processing for pixel data of an input image according to the reciprocal of the scale factor set in the scale factor setting register 10 without receiving indication of scaling up or scaling down, and outputs the processed pixel data.

When the integer part of the reciprocal of the scale factor set in the scale factor setting register 10 is “0”, the seamless pixel processing section 20 outputs pixel data of an image obtained by performing scale-up processing for an input image. When the integer part of the reciprocal of the scale factor is not “0”, the seamless pixel processing section 20 outputs pixel data of an image obtained by performing the scale-down processing for an input image.

Therefore, firmware for controlling the image processing device 100 need to merely designate the scale factor and need not set an operation mode which designates scaling up or scaling down of an image. Therefore, the amount of code of the firmware can be significantly reduced as shown in FIG. 18B.

The seamless pixel processing section 20 of the image processing device 100 may include an accumulator 30 which accumulates the reciprocal of the scale factor. The seamless pixel processing section 20 (accumulator 30) may output a validation signal “valid” which designates whether or not to thin out each pixel of an input image in the scale-down processing based on the accumulation result of the accumulator 30.

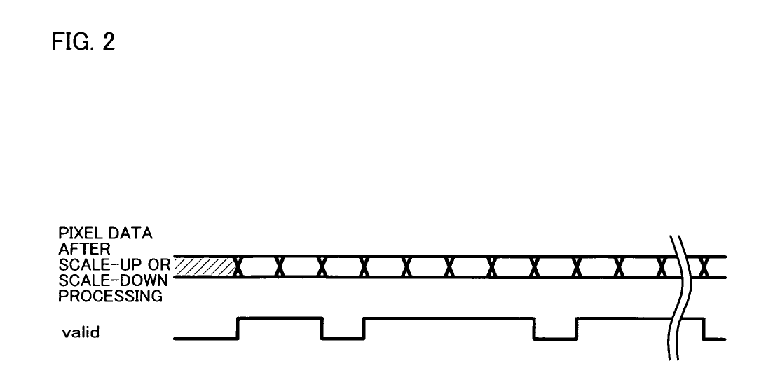

FIG. 2 shows an example of the relationship between the processed pixel data and the validation signal “valid”.

The validation signal “valid” changes to the H level or the L level in units of pixel data of each pixel. For example, the validation signal “valid” indicates that pixel data is valid when the validation signal “valid” is set at the H level, and indicates that pixel data is invalid when the validation signal “valid” is set at the L level. Therefore, a circuit which has received the processed pixel data and the validation signal “valid” from the image processing device 100 can determine whether or not to thin out the pixel data of each pixel by the scale-down processing based on the validation signal “valid”. This allows the circuit to thin out the pixel data which has determined to require thinning out based on the validation signal “valid” from the processed pixel data.

In FIG. 1, the seamless pixel processing section 20 may further include a filter calculation section 40. The filter calculation section 40 performs filter processing for pixel data of an input image using a filter coefficient corresponding to the accumulation result of the accumulator 30. The pixel data after the filter processing is the pixel data after the scale-up or scale-down processing. Specifically, the filter calculation section 40 performs the filter processing for the pixel data of the pixel after the scale-up or scale-down processing in order to interpolate a pixel into one or more pixels. Therefore, it is preferable that the seamless pixel processing section 20 include a coefficient look-up table (LUT) 50. The filter coefficient for performing the filter processing is set in advance in the coefficient LUT 50. Allowing the filter coefficient corresponding to the accumulation result of the accumulator 30 to be read from the coefficient LUT 50 prevents deterioration of the image quality of the image after the filter processing by the filter calculation section 40.

1.1 Image Scale-Up and Scale-Down Processing

The details of the image scale-up and scale-down processing according to one embodiment of the invention are described below.

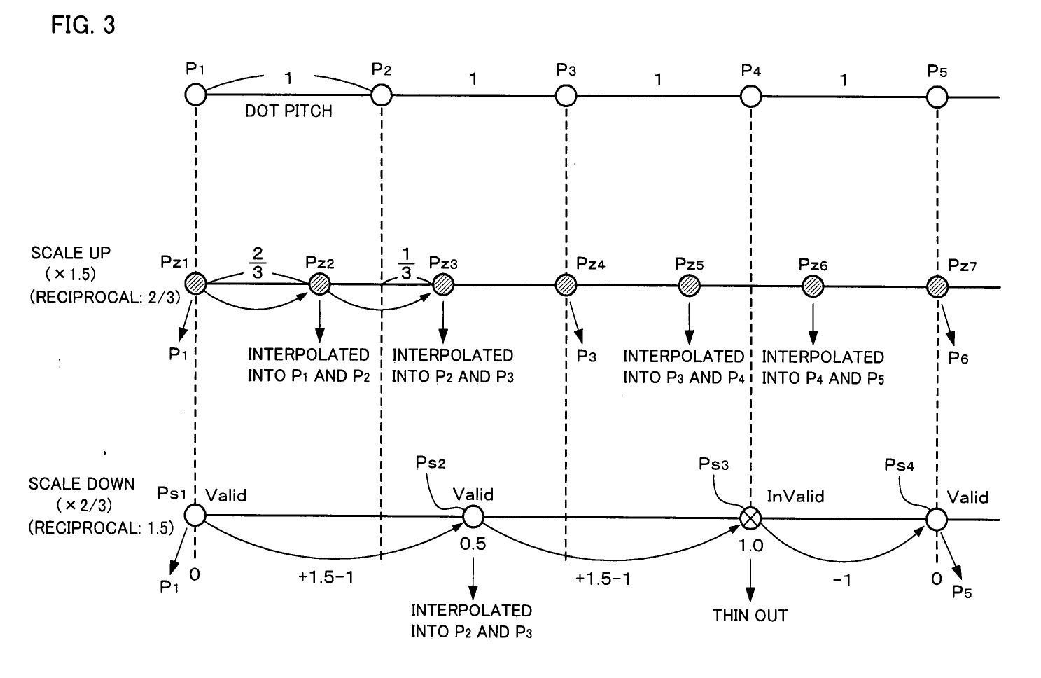

FIG. 3 is a diagram illustrative of image scale-up and scale-down processing according to one embodiment of the invention.

FIG. 3 illustrates the case of processing pixels of the original image arranged in the horizontal direction (horizontal scan direction) of the image. Note that the same description also applies to the case of processing pixels of the original image arranged in the vertical direction (vertical scan direction) of the image.

In FIG. 3, pixels P₁, P₂, P₃, P₄, P₅, . . . of the original image are arranged in the horizontal direction in a state in which the dot pitch between each pixel is normalized. Specifically, the distance between each pixel of the original image in the horizontal direction is “1”.

In the scale-up processing, pixels P_{Z1}, P_{Z2}, . . . of an image after the scale-up processing are generated corresponding to the pixels P₁, P₂, . . . of the original image. The pixels P_{Z1}, P_{Z2}, . . . of the image after the scale-up processing are not thinned out.

In the scale-down processing, pixels P_{S1}, P_{S2}, . . . of an image after the scale-down processing are generated corresponding to the pixels P₁, P₂, . . . of the original image. Since some of the pixels P_{S1}, P_{S2}, . . . of the image after the scale-down processing are thinned out, whether or not to thin out each of the pixels P_{S1}, P_{S2}, . . . of the processed image is designated. As a result, the validation signal “valid” shown in FIG. 2 is generated.

The case of scaling up the original image by a factor of 1.5 is described below. In this case, the reciprocal of the scale factor is “⅔” (=1/1.5).

For example, the pixel P_{Z1} of the image after the scale-up processing is caused to coincide with the pixel P₁ of the original image. Specifically, the position of the pixel P_{Z1} is “0” so that the pixel data of the pixel P_{Z1} is the pixel data of the pixel P₁ of the original image. The pixel data may be data including grayscale data of each RGB color component or data including a luminance component and two color difference components.

Then, “⅔” is accumulated to the value assigned to the pixel P_{Z1}.

As a result, the position of the pixel P_{Z2} is a value obtained by subtracting “1” from the value assigned to the pixel P_{Z2}. Specifically, the pixel P_{Z2} is positioned between the pixels P₁ and P₂ of the original image. Therefore, the pixel P_{Z2} is an interpolated pixel, and the pixel data of the pixel P_{Z2} is a value interpolated into the pixel data of the pixels P₁ and P₂, for example.

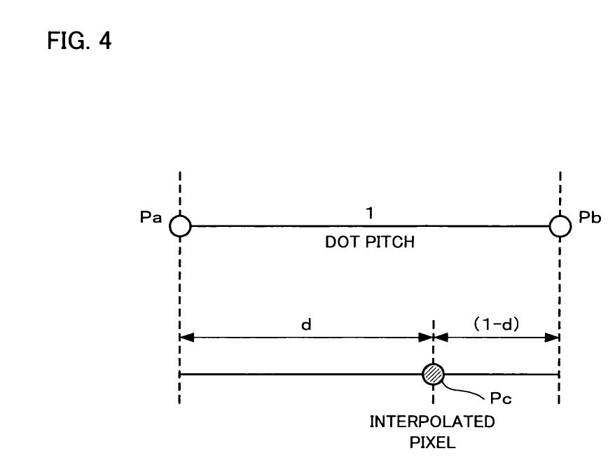

FIG. 4 is a diagram illustrative of pixel data of an interpolated pixel.

In FIG. 4, pixel data of an interpolated pixel P_{c} is calculated when the interpolated pixel P_{c} after processing the original image is positioned between pixels Pₐ and P_{b} of the original image. If the interpolated pixel P_{c} is positioned at a distance of d (0≦d≦1) from the pixel Pₐ, since the dot pitch between the pixels Pₐ and P_{b} is normalized, the interpolated pixel P_{c} is positioned at a distance of “1−d” from the pixel P_{b}.

When the pixel data of the pixel P is indicated by D(P), the pixel data D(P_{c}) of the interpolated pixel P_{c} is calculated by the following equation.
D(P_{c})=(1−d)×D(Pₐ)+d×D(P_{b} ) (1)

Therefore, the pixel data of the interpolated pixel is calculated by product-sum calculation of the distance d (interpolation coefficient) and the pixel data of the original image.

Since the dot pit is normalized, the distance d corresponds to the decimal fraction part of the accumulation result of the reciprocal of the scale factor for calculating the position of the interpolated pixel P_{c}. The decimal fraction part is associated with the interpolation coefficient when performing pixel data interpolation processing.

In this example, the pixel data of the pixel of the processed image is interpolated into the pixel data of the pixels of the original image at two points. Note that the pixel data may also be interpolated into the pixel data of the pixels of the original image at three or more points.

Since the pixel data of the interpolated pixel is calculated as described above, the pixel data D(P_{Z2}) of the pixel P_{Z2} shown in FIG. 3 is calculated by the following equation from the pixel data of the pixels P₁ and P₂ of the original image.
D(P_{Z2})=(1−⅔)×D(P₁)+⅔×D(P₂) (2)

Since the value assigned to the pixel P_{Z3} is “⅔+⅔=1+⅓”, the pixel data D(P_{Z3}) of the pixel P_{Z3} is calculated by the following equation from the pixel data of the pixels P₂ and P₃ of the original image.
D(P_{Z3})=(1−⅓)×D(P₂)+⅓×D(P₃) (3)

Likewise, the pixel data of the pixel P_{Z4} is the pixel data of the pixel P₃ of the original image, and the pixel data of the pixel Pz₅ is a value interpolated into the pixel data of the pixels P₃ and P₄ of the original image.

As described above, the pixel data of the image after the scale-up processing can be generated based on the pixel data of the pixels of the original image and the coefficient corresponding to the decimal fraction part of the accumulation result of the reciprocal of the scale factor in a state in which the dot pitch between the pixels is normalized.

The case of scaling down the original image by a factor of ⅔ is described below. In this case, the reciprocal of the scale factor is “1.5” (=1/(⅔).

For example, the pixel P_{S1} of the image after the scale-down processing is caused to coincide with the pixel P₁ of the original image. Specifically, the position of the pixel P_{S1} is “0” so that the pixel data of the pixel P_{S,} is the pixel data of the pixel P₁ of the original image.

Then, “1” is subtracted from the value assigned to the pixel P_{S1}, or “1.5−1” is added to the value assigned to the pixel P_{S1}. Since the reciprocal of the scale factor is greater than “1” in the scale-down processing, the pixel is interpolated into the subsequent pixels each time the value assigned to the processed pixel is decremented. As a result, the processed pixel is made valid when the integer part of the value assigned to the processed pixel is “0”, and is interpolated into the pixel data of the pixels of the original image as described above. In order to determine the next interpolated pixel, “1.5−1” is added to the value assigned to the pixel.

On the other hand, the processed pixel is made invalid when the integer part of the value assigned to the processed pixel is “1”, and “1” is subtracted from the value assigned to the pixel in order to determine the next interpolated pixel.

In FIG. 3, since the value assigned to the pixel P_{S1} is “0” so that the pixel P_{S1} is valid, “1.5−1” is added to the value assigned to the pixel P_{S1}. As a result, the value assigned to the pixel P_{S2} becomes “0.5”, and the value “0.5” is the position of the pixel P_{S2}. Specifically, the pixel P_{S2} is positioned between the pixels P₂ and P₃ of the original image. Therefore, the pixel P_{S2} is an interpolated pixel, and the pixel data of the pixel P_{S2} is a value interpolated into the pixel data of the pixels P₂ and P₃, for example. This example corresponds to the case where the distance d is “0.5” in FIG. 4.

The value assigned to the pixel P_{S3} becomes “1.0” (=0.5+1.5−1). Since the integer part of the value assigned to the pixel P_{S3} is “1”, the pixel P_{S3} is thinned out.

The value assigned to the pixel P_{S4} becomes “0.0” (=1.0−1). Therefore, the pixel P_{S4} is made valid.

As described above, the pixel data of the image after the scale-down processing can be generated and whether or not to thin out the processed pixel data can be determined by accumulating the reciprocal of the scale factor while decrementing the value assigned to the processed pixel in a state in which the dot pitch between the pixels is normalized.

A hardware configuration example of the image processing device 100 which realizes the above-described image scale-up and scale-down processing is described below.

1.2 Accumulator

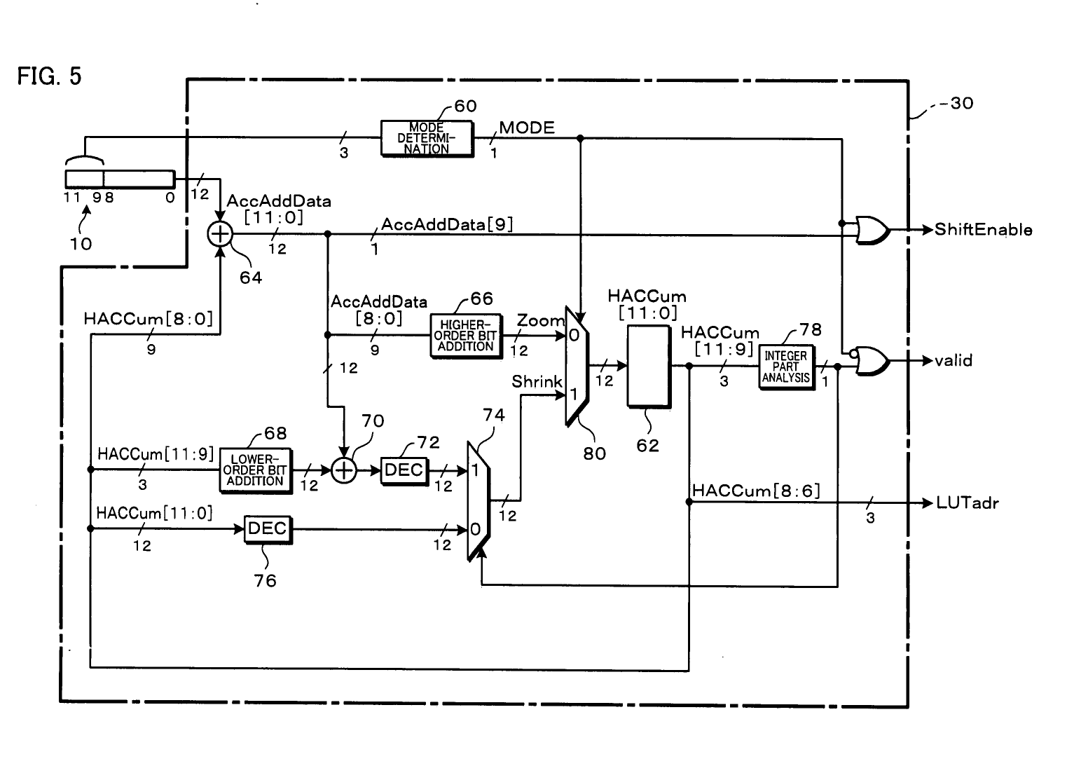

FIG. 5 is a block diagram of a configuration example of the accumulator 30 shown in FIG. 1.

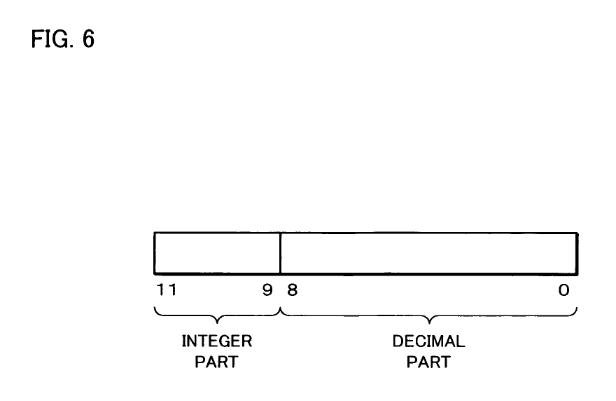

In this example, the scale factor setting register 10 has a 12-bit configuration as shown in FIG. 6, in which the data of the integer part is set in the higher-order three bits, and the data of the decimal fraction part is set in the lower-order nine bits.

The accumulator 30 includes a mode determination section 60. The mode determination section 60 outputs a mode signal MODE corresponding to the value set in the higher-order three bits of the 12-bit data set in the scale factor setting register 10. In more detail, when the value set in the higher-order three bits is “0”, the mode determination section 60 sets the mode signal MODE at the L level to designate a scale-up processing mode (zoom mode) in which the scale-up processing is performed. On the other hand, when the value set in the higher-order three bits is not “0”, the mode determination section 60 sets the mode signal MODE at the H level to designate a scale-down processing mode (shrink mode) in which the scale-down processing is performed.

The accumulator 30 includes a scale factor accumulator register 62 having a 12-bit configuration. A value “000000000000” is set in the scale factor accumulator register 62 at the time of initialization, for example. The accumulation result of the reciprocal of the scale factor is stored in the scale factor accumulator register 62 in synchronization with the change point of a pixel clock signal or a line clock signal (not shown). The pixel clock signal is a clock signal in units of pixels arranged in the horizontal direction, and the line clock signal is a clock signal in units of lines (horizontal scan periods).

An adder 64 adds the reciprocal of the scale factor set in the scale factor setting register 10 and a value HACCum[8:0] stored in the scale factor accumulator register 62, and outputs the addition result as data AccAddData[11:0]. The OR result of the data AccAddData[9] and the mode signal MODE is output as a shift enable signal ShiftEnable. Therefore, the shift enable signal ShiftEnable is fixed at the H level in the scale-down processing mode. The shift enable signal ShiftEnable is an enable control signal of a shift operation for updating the pixel data (processing target pixel data) processed by the filter calculation section 40. Therefore, in the scale-up processing mode, the shift enable signal ShiftEnable is set at the H level when the integer part of the data HACCum[11:0] (accumulation result) is not “0” so that the pixel data processed by the filter calculation section is updated, and the shift enable signal ShiftEnable is set at the L level when the integer part of the data HACCum[11:0] is “0” so that the pixel data processed by the filter calculation section is not updated.

A higher-order bit addition section 66 adds higher-order three bits “000” to the 9-bit data AccAddData[8:0], and outputs the resulting 12-bit data.

A lower-order bit addition section 68 adds lower-order bits “000000000” to the value HACCum[11:9] stored in the scale factor accumulator register 62, and outputs the resulting 12-bit data. An adder 70 adds the 12-bit data and the AccAddData[11:0], and a decrementer 72 decrements the value of the integer part of the addition result of the adder 70, and supplies the resulting data to a selector 74.

A decrementer 76 decrements the value of the integer part of the value HACCum[11:0] stored in the scale factor accumulator register 62, and supplies the resulting data to the selector 74.

An integer part analysis section 78 detects whether or not the value HACCum[11:9] stored in the scale factor accumulator register 62 is “0”. In more detail, the integer part analysis section 78 outputs a detection signal at the H level when the integer part analysis section 78 has detected that the value HACCum[11:9] is “0”, and outputs a detection signal at the L level when the integer part analysis section 78 has detected that the value HACCum[11:9] is not “0”. The OR result of the detection signal and an inversion signal of the mode signal MODE is output as the validation signal “valid”. Therefore, the validation signal “valid” is fixed at the H level in the scale-up processing mode. The data HACCum[8:6] is an address LUTadr of the coefficient LUT 50. In FIG. 5, only three bits are generated as the address of the coefficient LUT 50. However, the number of bits of the address of the coefficient LUT 50 is not limited thereto. Therefore, it suffices that the address of the coefficient LUT 50 be generated based on at least a part of the decimal fraction part of the accumulation result.

The detection signal from the integer part analysis section 78 functions as a select control signal of the selector 74. Specifically, when the detection signal from the integer part analysis section 78 is set at the L level, the selector 74 selects and outputs the output from the decrementer 76. When the detection signal from the integer part analysis section 78 is set at the H level, the selector 74 selects and outputs the output from the decrementer 72. Therefore, in the scale-down processing mode, the integer part of the value stored in the scale factor accumulator register 62 is decremented until the data HACCum[11:9] becomes a value other than “0”. The output from the selector 74 is supplied to a selector 80.

When mode signal MODE is set at the L level, the selector 80 selects and outputs the output from the higher-order bit addition section 66. When the mode signal MODE is set at the H level, the selector 80 selects and outputs the output from the selector 74. The output from the selector 80 is stored in the scale factor accumulator register 62.

The operation of the accumulator 30 shown in FIG. 5 is described below.

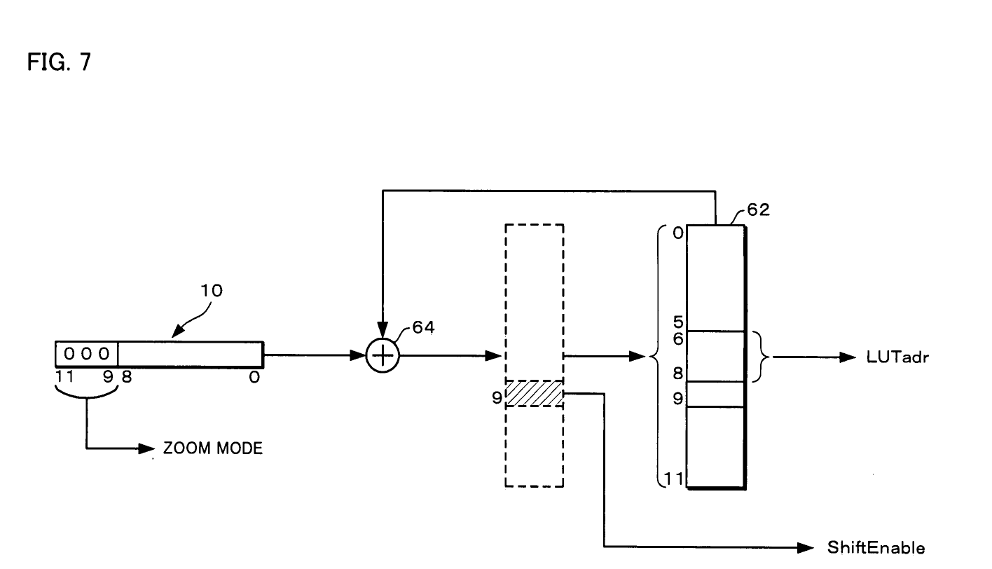

FIG. 7 schematically shows the operation of the accumulator 30 shown in FIG. 5 in the scale-up processing mode.

In FIG. 7, the sections shown in FIG. 5 are indicated by the same symbols. Description of these sections is appropriately omitted.

When the integer part of the reciprocal of the scale factor set in the scale factor setting register 10 is “0”, the mode signal MODE is set at the L level, as described above. The adder 64 adds the reciprocal of the scale factor and the value HACCum[8:0] stored in the scale factor accumulator register 62. The shift enable signal ShiftEnable is generated by the ninth bit (HACCum[9]) of the addition result. The reason that the shift enable signal ShiftEnable is generated based on the data HACCum[9] is as follows. Specifically, since the reciprocal of the scale factor accumulated in the scale-up processing mode is smaller than “1 ”, whether or not the integer part of the accumulation result is “0” can be determined by referring to the least significant bit of the integer part of the accumulation result.

The addition result is again stored in the scale factor accumulator register 62. The data HACCum[8:6] of the value stored in the scale factor accumulator register 62 is output as the address LUTadr for designating the coefficient set in the coefficient LUT 50.

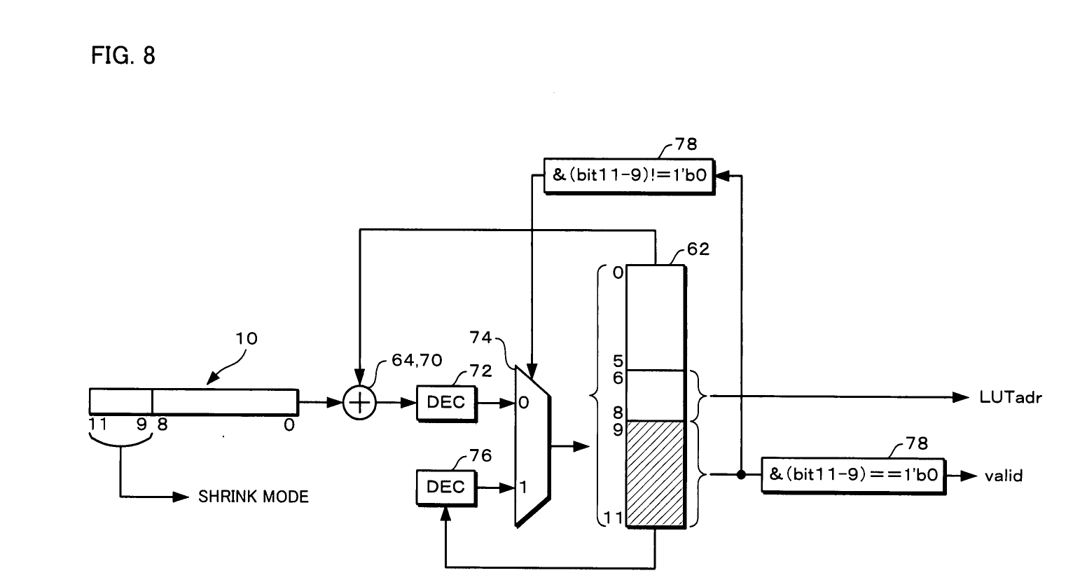

FIG. 8 schematically shows the operation of the accumulator 30 shown in FIG. 5 in the scale-down processing mode.

In FIG. 8, the sections shown in FIG. 5 are indicated by the same symbols. Description of these sections is appropriately omitted.

When the integer part of the reciprocal of the scale factor set in the scale factor setting register 10 is not “0”, the mode signal MODE is set at the H level, as described above. The adders 64 and 70 add the reciprocal of the scale factor and the value HACCum[11:0] stored in the scale factor accumulator register 62. The value of the integer part of the addition result is decremented by the decrementer 72. The decrementer 76 decrements the value of the integer part of the value HACCum[11:0] stored in the scale factor accumulator register 62. The output from one of the decrementers 72 and 76 is selected based on whether or not the value HACCum[11:9] stored in the scale factor accumulator register 62 is “0”, and again stored in the scale factor accumulator register 62.

The data HACCum[8:6] stored in the scale factor accumulator register 62 is output as the address LUTadr of the coefficient LUT 50. The validation signal “valid” is output based on the data HACCum[11:9] stored in the scale factor accumulator register 62.

Therefore, in the scale-down processing mode, the validation signal “valid” which designates whether or not to thin out each pixel can be output based on the accumulation result in the scale factor accumulator register 62.

1.3 Coefficient LUT

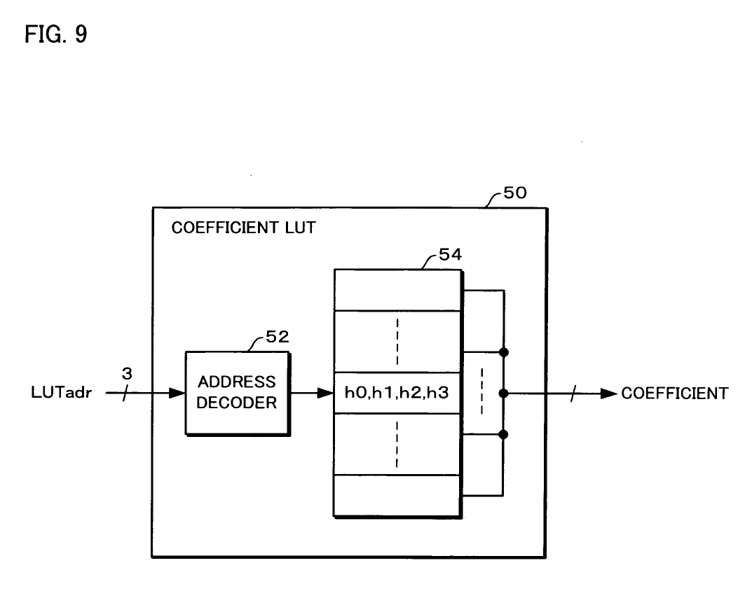

FIG. 9 is a block diagram of a configuration example of the coefficient LUT 50 shown in FIG. 1.

The coefficient LUT 50 may include an address decoder 52 and a coefficient memory 54. The address decoder 52 decodes the address LUTadr from the accumulator 30, and designates the storage area of the coefficient memory 54. The coefficient memory 54 holds eight (=2³) coefficient groups, and outputs the coefficient group designated by the address decoder 52 to the filter calculation section 40, for example.

In FIG. 9, the coefficient memory 54 holds the eight coefficient groups. However, the number of coefficient groups is not limited thereto.

1.4 Filter Calculation Section

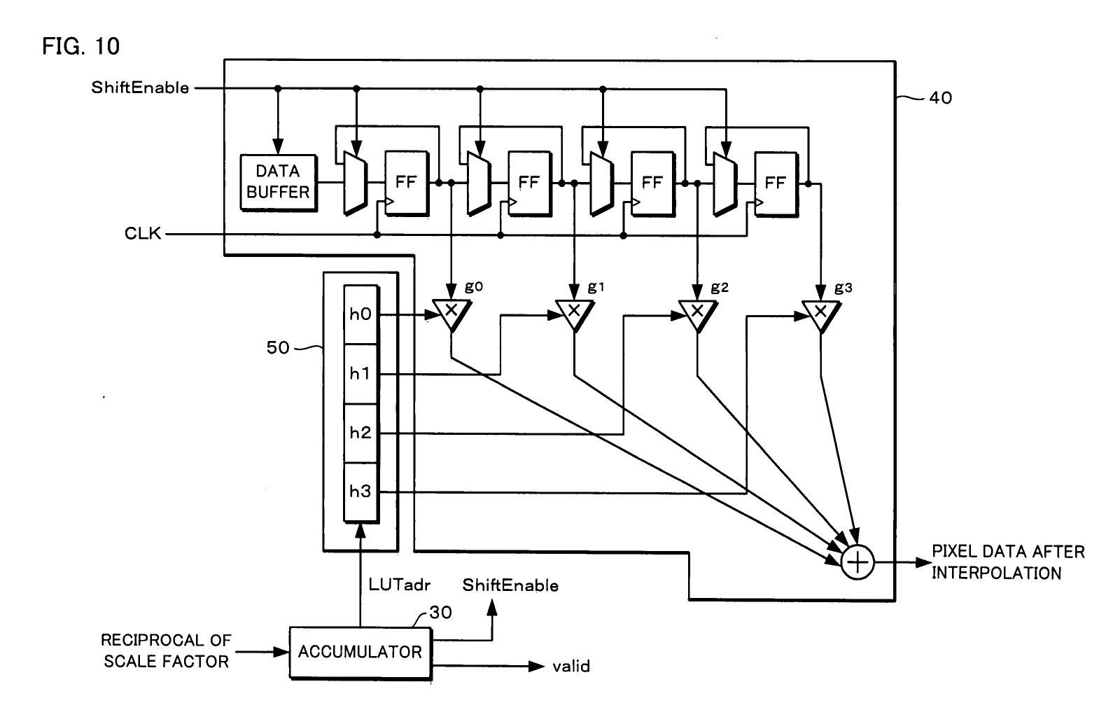

FIG. 10 is a block diagram of a configuration example of the accumulator 30, the coefficient LUT 50, and the filter calculation section 40 shown in FIG. 1.

In FIG. 10, the sections shown in FIGS. 1, 5, and 9 are indicated by the same symbols. Description of these sections is appropriately omitted. In FIG. 10, the filter calculation section 40 performs four-tap filter processing. However, the number of taps is not limited thereto.

The filter calculation section 40 includes a data buffer and four flip-flops (FF). The four flip-flops are serially connected to form a shift register. A clock signal CLK (pixel clock signal or line clock signal) is supplied to each flip-flop, for example. When the shift enable signal ShiftEnable from the accumulator 30 is set at the H level, the pixel data is read from the data buffer, and a shift operation is performed in synchronization with the clock signal CLK. In the filter calculation section 40, a shift clock signal may be supplied as the clock signal CLK without providing a selector in front of the shift register.

The output from each flip-flop is respectively input to a multiplier. The coefficient LUT 50 outputs coefficient groups h0, h1, h2, and h3 corresponding to the address LUTadr from the accumulator 30. Each coefficient of the coefficient group output corresponding to the address LUTadr is supplied to the multiplier.

The output from each multiplier is supplied to an adder, and the output from the adder is pixel data after interpolation. The pixel data after interpolation is pixel data after the scale-up or scale-down processing.

When the outputs from the flip-flops are indicated by g0, g1, g2, and g3 and the output from the adder is indicated by D(P), the output D(P) is expressed by the following equation.
D(P)=g0×h0+g1×h1+g2×h2+g3×h3 (4)

The image processing device 100 performs the scale-up processing for pixel data of an input image when the integer part of the reciprocal of the scale factor set in the scale factor setting register 10 is “0”, and performs the scale-down processing for pixel data of an input image when the integer part of the reciprocal of the scale factor is not

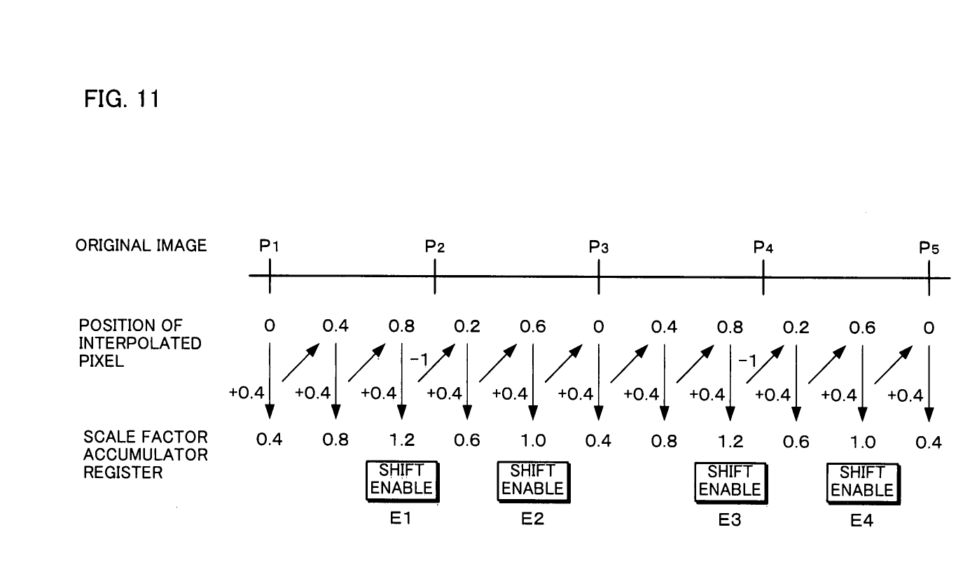

FIG. 11 is a diagram illustrative of an example of the scale-up processing of the image processing device 100 according to one embodiment of the invention.

FIG. 11 shows an example in which the scale-up factor is “2.5” (the reciprocal of the scale factor is “0.4”). In the scale-up processing, the processed pixels are entirely valid.

Specifically, when the integer part of the reciprocal of the scale factor is “0” and the integer part of the accumulation result of the accumulator 30 is not “0”, the image processing device 100 changes the shift enable signal ShiftEnable to the H level as described with reference to FIGS. 5 and 7 to cause the shift register of the filter calculation section 40 shown in FIG. 10 to perform the shift operation. This enables the pixel data processed by the filter calculation section 40 to be updated. The pixel data of an image after the scale-up processing can be generated by performing product-sum calculation of the updated pixel data and the coefficient corresponding to at least a part (HACCum[8:6] in FIG. 7) of the decimal fraction part of the accumulation result of the accumulator 30.

When the integer part of the reciprocal of the scale factor is “0” and the integer part of the accumulation result of the accumulator 30 is “0”, the image processing device 100 changes the shift enable signal ShiftEnable to the L level as described with reference to FIGS. 5 and 7 to disable the shift operation of the shift register of the filter calculation section 40 shown in FIG. 10. This prevents the pixel data processed by the filter calculation section 40 from being updated. The pixel data of an image after the scale-up processing can be generated by performing product-sum calculation of the previous pixel data used in the filter calculation section 40 and the coefficient corresponding to at least a part (HACCum[8:6] in FIG. 7) of the decimal fraction part of the accumulation result of the accumulator 30.

In FIG. 11, when the accumulation result is “1.2” and “1.0” (E1, E2, E3, E4), the shift enable signal ShiftEnable is changed to the H level, so that the pixel data after interpolation is generated corresponding to the pixel data after the shift operation. In other cases, the shift enable signal ShiftEnable is changed to the L level, so that the pixel data after interpolation is generated corresponding to the previous processing target pixel data by using the coefficient corresponding to the position of a new interpolated pixel.

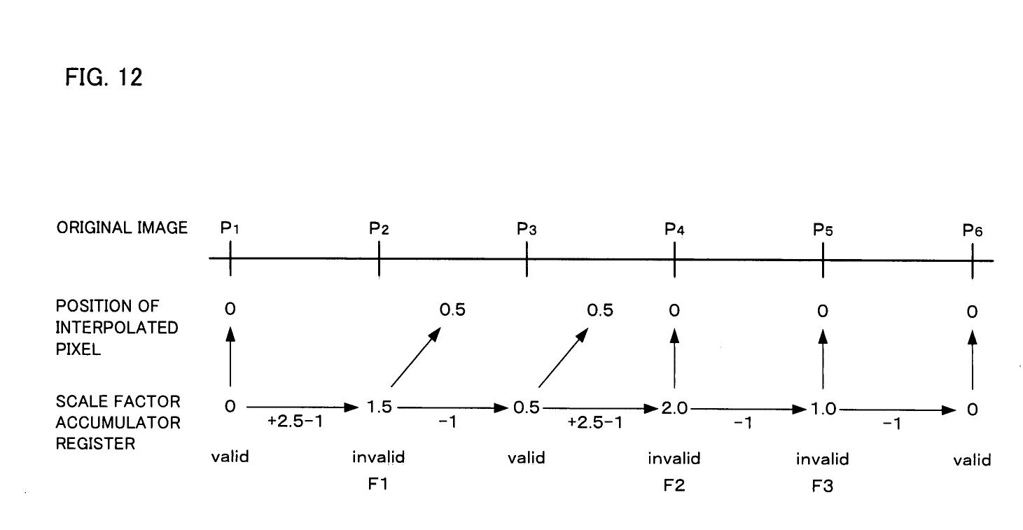

FIG. 12 is a diagram illustrative of an example of the scale-down processing of the image processing device 100 according to one embodiment of the invention.

FIG. 12 shows an example in which the scale-down factor is “0.4” (the reciprocal of the scale factor is “2.5”). In the scale-down processing, the shift enable signal ShiftEnable is always set at the H level.

Specifically, when the integer part of the reciprocal of the scale factor is not “0” and the integer part of the accumulation result of the accumulator 30 is not “0”, the image processing device 100 changes the validation signal “valid” to the L level to cause the processed pixel to be thinned out. The image processing device 100 decrements the accumulation result (integer part) using the decrementer 76 as shown in FIG. 8, but does not update the output from the filter calculation section 40.

When the integer part of the reciprocal of the scale factor is not “0” and the integer part of the accumulation result of the accumulator 30 is “0”, the image processing device 100 decrements the integer part of the addition result of the reciprocal of the scale factor and the accumulation result (output from the accumulator 30) using the decrementer 72. The pixel data of an image after the scale-down processing can be generated by performing product-sum calculation of the pixel data processed by the filter calculation section 40 and the coefficient corresponding to at least a part of the decimal fraction part of the accumulation result.

In FIG. 12, the validation signal “valid” is changed to the L level when the accumulation result is “1.5”, “2.0”, and “1.0” (F1, F2, F3). In other cases, the validation signal “valid” is changed to the H level, and the pixel data after interpolation is generated corresponding to the pixel data after the shift operation.

As described above, the image processing device 100 according to one embodiment of the invention can generate the pixel data obtained by subjecting the input image to the scale-up or scale-down processing according to the reciprocal of the scale factor set in the scale factor setting register 10. The image processing device 100 makes it unnecessary to provide a divider for calculating the reciprocal of the scale factor. Moreover, it is unnecessary to compare the accumulation result of the reciprocal of the scale factor with a count value of a pixel counter. Therefore, since an increase in the number of bits used in the pixel counter can be prevented, it is possible to deal with an increase in the screen size of an electro-optical device without being limited to the number of bits of the pixel counter.

2. Display Controller

A display controller to which the image processing device 100 according to one embodiment of the invention is applied is described below.

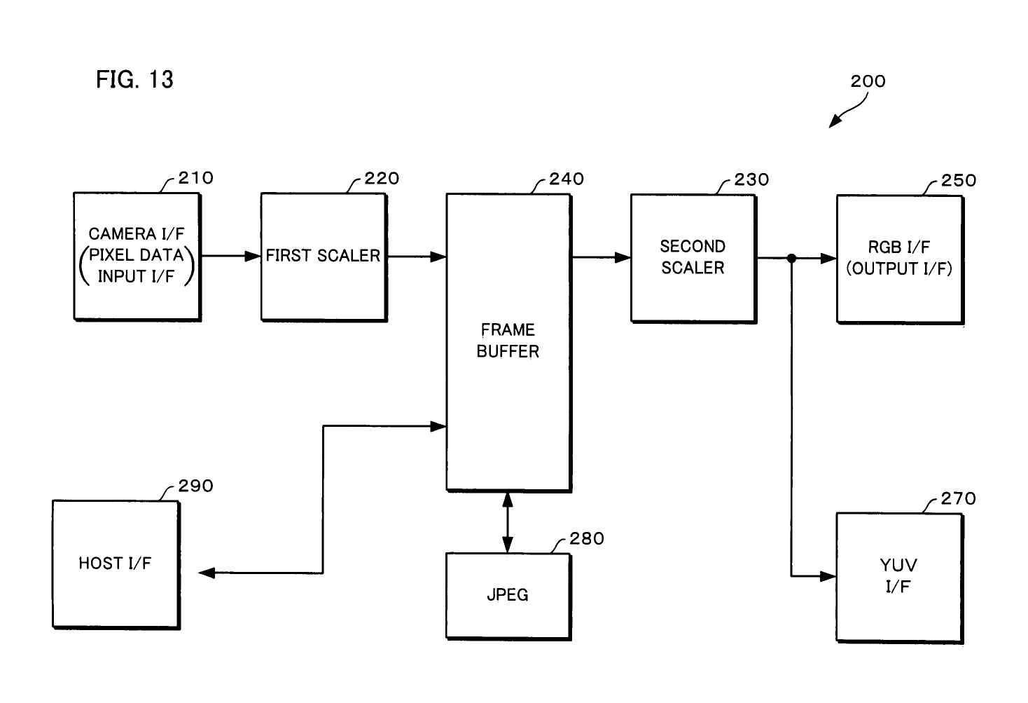

FIG. 13 is a block diagram of a configuration example of a display controller to which the image processing device 100 according to one embodiment of the invention is applied.

The display controller 200 includes a camera interface (I/F) (pixel data input I/F in a broad sense) 210, first and second scaler circuits 220 and 230, a frame buffer 240, and an RGB I/F (output I/F in a broad sense) 250. Pixel data of an input image is input to the camera I/F 210. In more detail, pixel data of an image from a camera module including a CCD camera or a CMOS camera is input to the camera I/F 210. The camera I/F 210 performs pixel data interface processing (reception from the camera module or signal buffering), and outputs the pixel data after the interface processing to the first scaler circuit 220.

The first scaler circuit 220 performs the scale-up or scale-down processing for the pixel data of the image input from the camera I/F 210.

The frame buffer 240 stores pixel data for at least one frame (one screen) of an electro-optical device driven by a display driver. connected with the RGB I/F 250, for example. The data processed by the first scaler circuit 220 is stored in the frame buffer 240.

The second scaler circuit 230 performs the scale-up or scale-down processing of an image expressed by the pixel data read from the frame buffer 240.

The RGB I/F 250 performs interface processing for outputting the data processed by the second scaler circuit 230. The RGB I/F 250 performs pixel data interface processing (transmission to the display driver or signal buffering), and outputs the pixel data after the interface processing to the display driver (not shown). The RGB I/F 250 includes a synchronization signal generation circuit (not shown). The RGB I/F 250 generates display synchronization signals (e.g. vertical synchronization signal VSYNC which specifies one vertical scan period (e.g. scan period of one frame), horizontal synchronization signal HSYNC which specifies one horizontal scan period, and dot clock signal DCLK) for driving the electro-optical device, and supplies the synchronization signals to the display driver, for example. The RGB I/F 250 outputs the pixel data in each frame in synchronization with the vertical synchronization signal and the dot clock signal.

At least one of the first and second scaler circuits 220 and 230 includes a horizontal direction image processing section which performs the scale-up or scale-down processing for pixel data in the horizontal direction of an image, and a vertical direction image processing section which performs the scale-up or scale-down processing for pixel data in the vertical direction of an image. At least one of the horizontal direction image processing section and the vertical direction image processing section includes the image processing device 100 according to one embodiment of the invention.

The display controller 200 can output pixel data obtained by converting the output from the second scaler circuit 230 into YUV data in the same manner as RGB pixel data. Therefore, the display controller 200 may include a YUV I/F 270. The YUV I/F 270 performs interface processing (transmission to a CRT device or signal buffering) of the pixel data from the second scaler circuit 230, and outputs the pixel data after the interface processing to the CRT device (not shown).

The display controller 200 may include a JPEG circuit 280 which performs compression or decompression of the data saved in the frame buffer 240. The JPEG circuit 280 reads the data saved in the frame buffer 240, performs compression or decompression according to the JPEG standard, and writes the processed data into the frame buffer 240.

The display controller 200 may include a host I/F 290. Data from a host (not shown) is input to the host I/F 290. The host I/F 290 performs interface processing (reception from the host or signal buffering), and supplies the data after the interface processing to the frame buffer 240. The host I/F 290 supplies the data read from the frame buffer 240 to the host through the host I/F 290. In this case, the host I/F 290 performs interface processing (transmission to the host or signal buffering), and supplies the data after the interface processing to the host.

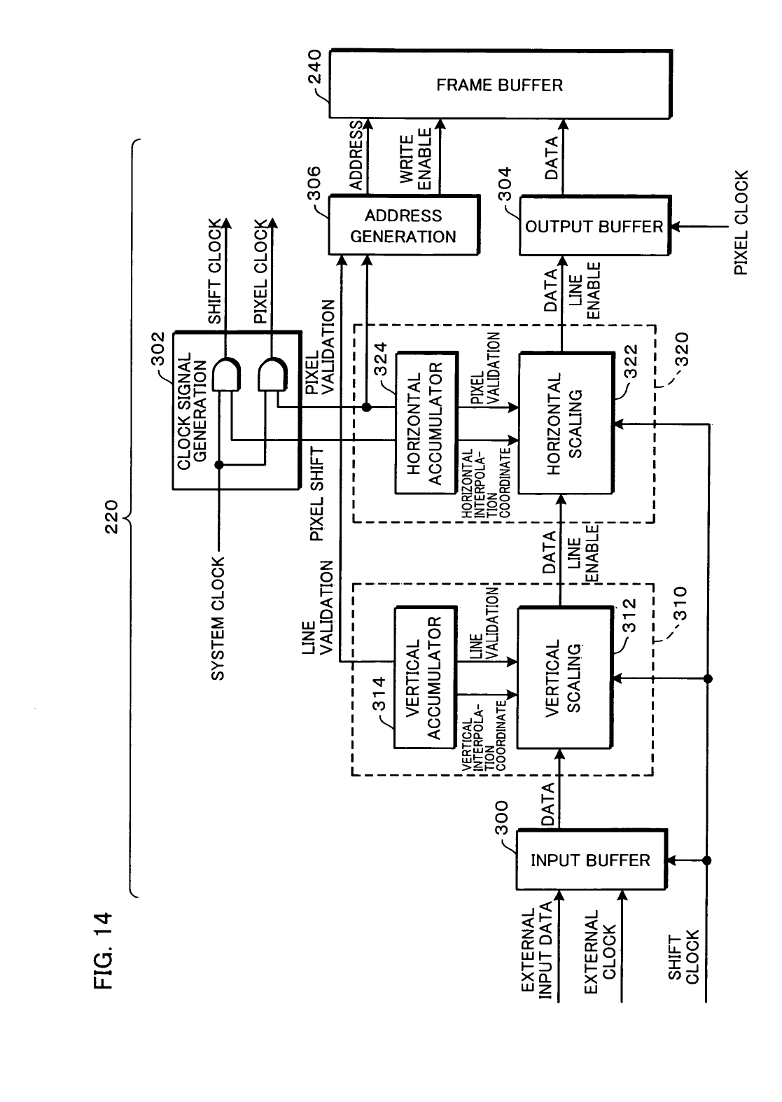

FIG. 14 is a block diagram of a configuration example of the first scaler circuit 220 shown in FIG. 13.

In FIG. 14, the sections shown in FIG. 13 are indicated by the same symbols. Description of these sections is appropriately omitted. Each section of the first scaler circuit 220 shown in FIG. 14 operates in synchronization with a system clock signal. The pixel data input as external input data through the camera I/F 210 is buffered by an input buffer 300 in synchronization with an external clock signal from the camera I/F 210.

A clock signal generation circuit 302 generates a shift clock signal by mask-controlling the system clock signal based on a pixel shift signal, and generates a pixel clock signal mask by mask-controlling the system clock signal based on a pixel validation signal.

The first scaler circuit 220 includes a vertical direction image processing section 310 which performs the scale-up or scale-down processing for pixel data in the vertical direction of an input image, and a horizontal direction image processing section 320 which performs the scale-up or scale-down processing for pixel data in the horizontal direction of the input image.

The vertical direction image processing section 310 includes a vertical scale factor setting register (not shown), a vertical scaling circuit 312, and a vertical accumulator circuit 314. The vertical scale factor setting register (not shown) has the function of the scale factor setting register 10 shown in FIG. 1. The vertical scaling circuit 312 has the function of the coefficient LUT 50 and the filter calculation section 40 shown in FIG. 1. The vertical accumulator circuit 314 has the function of the accumulator 30 shown in FIG. 1. The host (not shown) sets the reciprocal of the scale factor in the vertical direction of the image in the vertical scale factor setting register.

The horizontal direction image processing section 320 includes a horizontal scale factor setting register (not shown), a horizontal scaling circuit 322, and a horizontal accumulator circuit 324. The horizontal scale factor setting register (not shown) has the function of the scale factor setting register 10 shown in FIG. 1. The horizontal scaling circuit 322 has the function of the coefficient LUT 50 and the filter calculation section 40 shown in FIG. 1. The horizontal accumulator circuit 324 has the function of the accumulator 30 shown in FIG. 1. The host (not shown) sets the reciprocal of the scale factor in the horizontal direction of the image in the horizontal scale factor setting register.

The vertical accumulator circuit 314 accumulates the reciprocal of the scale factor set in the vertical scale factor setting register, and outputs vertical interpolation coordinates (address of the coefficient LUT), a line validation signal which corresponds to the validation signal “valid”, and a line shift signal which corresponds to the shift enable signal ShiftEnable. The vertical scaling circuit 312 performs product-sum calculation of the coefficient corresponding to the vertical interpolation coordinates and the pixel data from the input buffer 300, and outputs the calculation result to the horizontal scaling circuit 322. The vertical scaling circuit 312 outputs the line validation signal to the horizontal scaling circuit 322 as a line enable signal.

The horizontal accumulator circuit 314 accumulates the reciprocal of the scale factor set in the horizontal scale factor setting register, and outputs horizontal interpolation coordinates (address of the coefficient LUT), the pixel validation signal which corresponds to the validation signal “valid”, and the pixel shift signal which corresponds to the shift enable signal ShiftEnable.

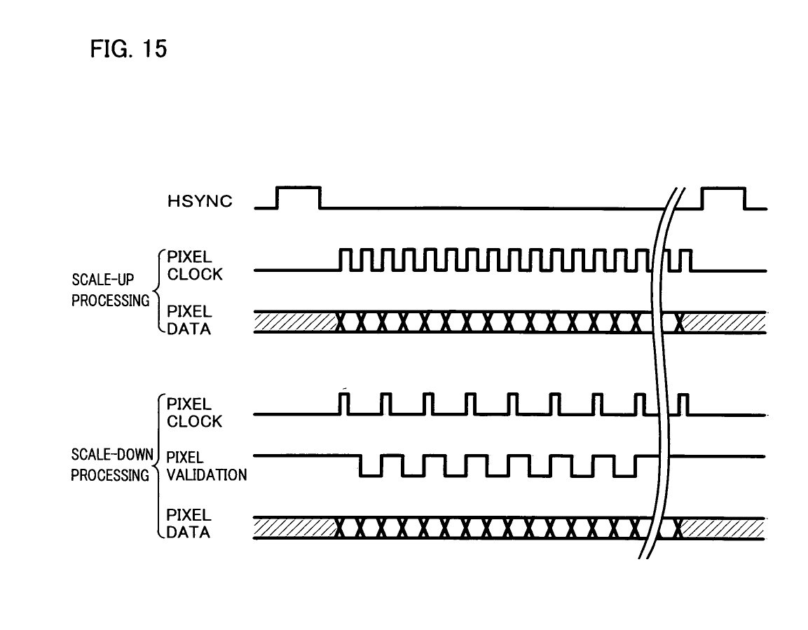

FIG. 15 shows the relationship among the pixel clock signal, the pixel validation signal, and the pixel data. FIG. 15 shows the relationship between the pixel clock signal and the pixel data in the scale-up processing and the relationship among the pixel clock signal, the pixel validation signal, and the pixel data in the scale-down processing.

In FIG. 14, the horizontal scaling circuit 322 performs product-sum calculation of the coefficient corresponding to the horizontal interpolation coordinates and the data output from the vertical scaling circuit 312, and outputs the calculation result to the output buffer 304. The horizontal scaling circuit 322 outputs the pixel validation signal to the output buffer 304 as the line enable signal.

The data output from the horizontal scaling circuit 322 is stored in the output buffer 304 in synchronization with the pixel clock signal. In this case, the data when the line enable signal is active is stored in the output buffer 304.

This allows the horizontal direction image processing section 320 to perform the scale-up or scale-down processing for the pixel data which has been made valid (always valid in the scale-up processing) in the scale-down processing by the vertical direction image processing section 310. Only the pixel data which has been made valid (always valid in the scale-up processing) in the scale-down processing by the horizontal direction image processing section 320 is stored in the output buffer 304.

The address generation circuit 306 may generate the write address of the frame buffer 240 and generate the write enable signal to the frame buffer 240 based on the line validation signal from the vertical accumulator circuit 314 and the pixel validation signal from the horizontal accumulator circuit 324.

As a result, the pixel data stored in the output buffer 340 is stored in the frame buffer 240.

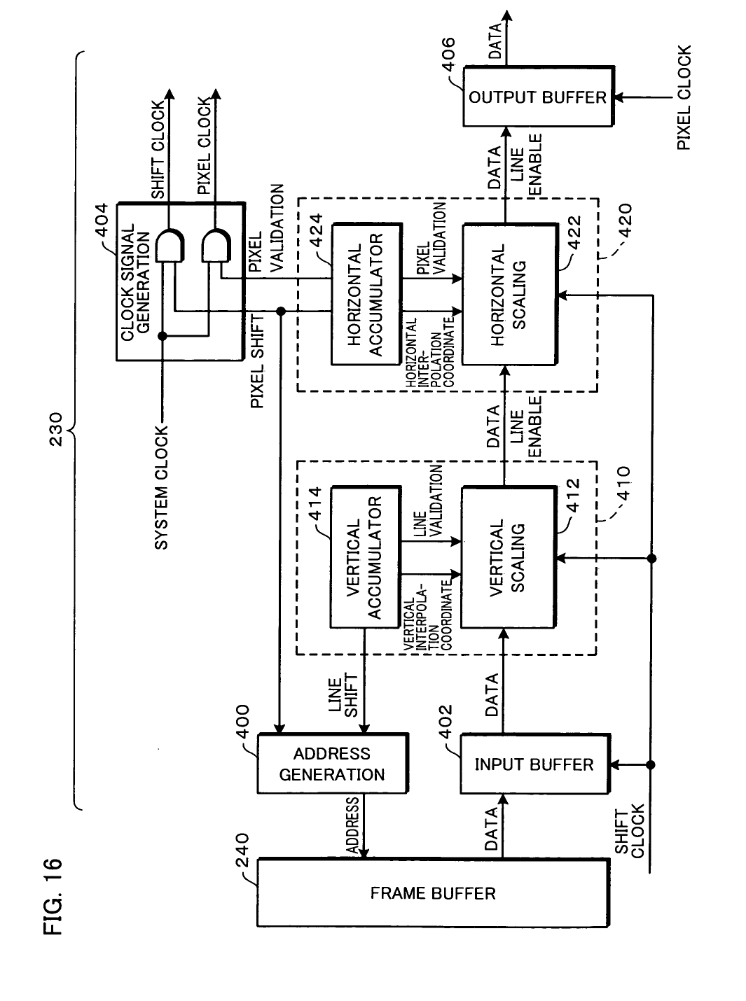

FIG. 16 is a block diagram of a configuration example of the second scaler circuit 230 shown in FIG. 13.

In FIG. 16, the sections shown in FIG. 13 are indicated by the same symbols. Description of these sections is appropriately omitted. Each section of the second scaler circuit 230 shown in FIG. 16 operates in synchronization with the system clock signal.

The data read from the frame buffer 240 based on the address generated by the address generation circuit 400 is buffered by an input buffer 402.

A clock signal generation circuit 404 generates a shift clock signal by mask-controlling the system clock signal based on a pixel shift signal, and generates a pixel clock signal mask by mask-controlling the system clock signal based on a pixel validation signal.

The second scaler circuit 230 includes a vertical direction image processing section 410 which performs the scale-up or scale-down processing for pixel data in the vertical direction of an input image (image expressed by the pixel data stored in the frame buffer 240), and a horizontal direction image processing section 420 which performs the scale-up or scale-down processing for pixel data in the horizontal direction of the input image.

The vertical direction image processing section 410 includes a vertical scale factor setting register (not shown), a vertical scaling circuit 412, and a vertical accumulator circuit 414. The vertical scale factor setting register (not shown) has the function of the scale factor setting register 10 shown in FIG. 1. The vertical scaling circuit 412 has the function of the coefficient LUT 50 and the filter calculation section 40 shown in FIG. 1. The vertical accumulator circuit 414 has the function of the accumulator 30 shown in FIG. 1. The host (not shown) sets the reciprocal of the scale factor in the vertical direction of the image in the vertical scale factor setting register.

The horizontal direction image processing section 420 includes a horizontal scale factor setting register (not shown), a horizontal scaling circuit 422, and a horizontal accumulator circuit 424. The horizontal scale factor setting register (not shown) has the function of the scale factor setting register 10 shown in FIG. 1. The horizontal scaling circuit 422 has the function of the coefficient LUT 50 and the filter calculation section 40 shown in FIG. 1. The horizontal accumulator circuit 424 has the function of the accumulator 30 shown in FIG. 1. The host (not shown) sets the reciprocal of the scale factor in the horizontal direction of the image in the horizontal scale factor setting register.

The function of the vertical direction image processing section 410 is the same as that of the vertical direction image processing section 310 shown in FIG. 14. Therefore, detailed description is omitted. The function of the vertical direction image processing section 420 is the same as that of the vertical direction image processing section 320 shown in FIG. 14. Therefore, detailed description is omitted.

The line shift signal from the vertical accumulator circuit 414 is supplied to the address generation circuit 400. The pixel shift signal from the horizontal accumulator circuit 424 is supplied to the address generation circuit 400. The address generation circuit 400 generates the read address of the frame buffer 240 based on the line shift signal and the pixel shift signal.

The horizontal scaling circuit 422 performs product-sum calculation of the coefficient corresponding to the horizontal interpolation coordinates and the data output from the vertical scaling circuit 412, and outputs the calculation result to the output buffer 406.

The data output from the horizontal scaling circuit 422 is stored in the output buffer 406 in synchronization with the pixel clock signal. In this case, only the data when the line enable signal is active is stored in the output buffer 406.

This allows the horizontal direction image processing section 420 to perform the scale-up or scale-down processing for the pixel data which has been made valid (always valid in the scale-up processing) in the scale-down processing by the vertical direction image processing section 410. Only the pixel data which has been made valid (always valid in the scale-up processing) in the scale-down processing by the horizontal direction image processing section 420 is stored in the output buffer 406.

As a result, the pixel data stored in the output buffer 406 is output to the RGB I/F 250 or the YUV I/F 270.

3. Electronic Instrument

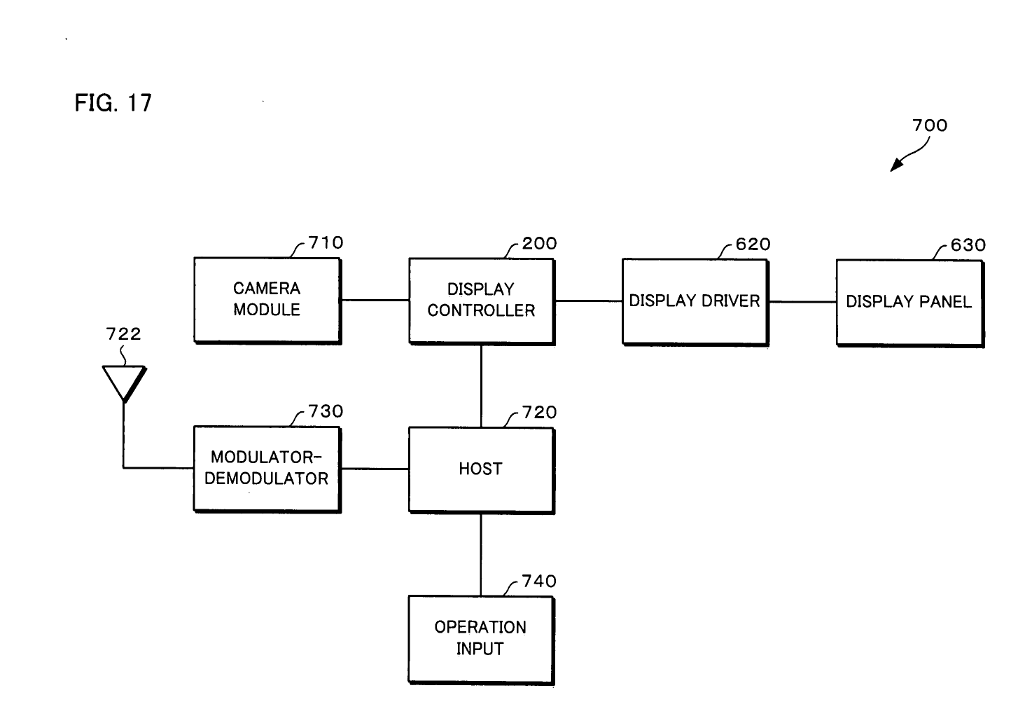

FIG. 17 is a block diagram showing a configuration example of an electronic instrument according to one embodiment of the invention. FIG. 17 is a block diagram showing a configuration example of a portable telephone as an example of the electronic instrument.

A portable telephone 700 includes the display controller 200 shown in FIG. 16. The portable telephone 700 includes a camera module 710. The camera module 710 includes a CCD camera, and supplies data of an image captured by the CCD camera to the display controller 200.

The portable telephone 700 includes a display panel 630. A liquid crystal display panel may be used as the display panel 630. In this case, the display panel 630 is driven by a display driver 620. The display panel 630 includes scan lines, data lines, and pixels. The display driver 620 has the function of a scan driver which selects the scan lines in units of one or more scan lines, and has the function of a data driver which supplies voltage corresponding to pixel data to the data lines.

The display controller 200 is connected with the display driver 620, and supplies pixel data in the RGB format to the display driver 620. The pixel data may be converted into the RGB format from the YUV format in the display controller 200.

A host 720 is connected with the display controller 200. The host 720 controls the display controller 200. The host 720 demodulates pixel data received through an antenna 722 using a modulator-demodulator section 730, and supplies the demodulated pixel data to the display controller 200. The display controller 200 causes the display driver 620 to display an image in the display panel 630 based on the pixel data.

The host 720 modulates pixel data generated by the camera module 710 using the modulator-demodulator section 730, and directs transmission of the modulated data to another communication device through the antenna 722.

The host 720 transmits or receives pixel data, captures an image using the camera module 710, and displays an image in the display panel based on operation information from an operation input section 740.

In FIG. 17, the liquid crystal display panel is described as an example of the display panel 630. However, the display panel 630 is not limited thereto. The display panel 630 may be an electroluminescent display device or a plasma display device. The invention may be applied to a display controller which supplies pixel data to a display driver which drives such a display panel. The display controller 200 may output YUV pixel data to a CRT device connected with the display controller 200 through an output terminal (not shown).

The invention is not limited to the above-described embodiments, and various modifications can be made within the scope of the invention.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. An image processing device for performing scale-up and scale-down processing of an input image, the image processing device comprising:
a scale factor setting register in which a reciprocal of a scale factor at which the input image is scaled up or scaled down is set;
an accumulator which accumulates the reciprocal of the scale factor; and
a seamless pixel processing section which performs the scale-up or scale-down processing of an image based on an accumulation result of the accumulator, the seamless pixel processing section outputting pixel data of an image obtained by subjecting the input image to the scale-up processing when an integer part of the reciprocal of the scale factor is “0”, outputting pixel data of an image obtained by subjecting the input image to the scale-down processing when the integer part of the reciprocal of the scale factor is not “0”, and outputting a validation signal, which designates whether or not to thin out each pixel of the input image, during the scale-down processing, based on the accumulation result of the accumulator.

2. The image processing device as defined in claim 1,
wherein the seamless pixel processing section includes a filter calculation section which performs product-sum calculation based on pixel data of the input image and an output from the accumulator to generates the pixel data after the scale-up or scale-down processing;
wherein, when the integer part of the reciprocal of the scale factor is “0” and an integer part of the accumulation result is not “0”, the seamless pixel processing section updates pixel data to be processed by the filter calculation section, and performs product-sum calculation of the updated pixel data and a coefficient corresponding to at least a part of a decimal fraction part of the accumulation result to generate the pixel data of the image after the scale-up processing;
wherein, when the integer part of the reciprocal of the scale factor is “0” and the integer part of the accumulation result is “0”, the seamless pixel processing section performs product-sum calculation of pixel data updated previously and a coefficient corresponding to at least a part of the decimal fraction part of the accumulation result without updating pixel data to be processed by the filter calculation section to generate the pixel data of the image after the scale-up processing;
wherein, when the integer part of the reciprocal of the scale factor is not “0” and the integer part of the accumulation result is not “0”, the seamless pixel processing section decrements the integer part of the accumulation result and does not update an output from the filter calculation section; and
wherein, when the integer part of the reciprocal of the scale factor is not “0” and the integer part of the accumulation result is “0”, the seamless pixel processing section decrements an integer part of an addition result of the reciprocal of the scale factor and the output from the accumulator, and performs product-sum calculation of pixel data to be processed by the filter calculation section and a coefficient corresponding to at least a part of the decimal fraction part of the accumulation result to generate the pixel data of the image after the scale-down processing.

3. An image processing device for performing scale-up and scale-down processing of an input image, the image processing device comprising:
a scale factor setting register in which a reciprocal of a scale factor at which the input image is scaled up or scaled down is set; and
a seamless pixel processing section which performs the scale-up or scale-down processing of an image based on the reciprocal of the scale factor, the seamless pixel processing section outputting pixel data of an image obtained by subjecting the input image to the scale-up processing when an integer part of the reciprocal of the scale factor is “0”, and outputting pixel data of an image obtained by subjecting the input image to the scale-down processing when the integer part of the reciprocal of the scale factor is not “0”.

4. An image processing method for performing scale-up and scale-down processing of an input image, the method comprising:
setting a reciprocal of a scale factor at which the input image is scaled up or scaled down in a scale factor setting register;
outputting pixel data of an image obtained by subjecting the input image to the scale-up processing when the integer part of the reciprocal of the scale factor set in the scale factor setting register is “0”; and
outputting pixel data of an image obtained by subjecting the input image to the scale-down processing when the integer part of the reciprocal of the scale factor is not “0”.

5. The image processing method as defined in claim 4, comprising:
accumulating the reciprocal of the scale factor; and
designating whether or not to thin out each pixel of the input image, during the scale-down processing, based on an accumulation result of the reciprocal of the scale factor.

6. The image processing method as defined in claim 5,
wherein, when the integer part of the reciprocal of the scale factor is “0” and an integer part of the accumulation result is not “0”, processing target pixel data is updated, and product-sum calculation of the updated pixel data and a coefficient corresponding to at least a part of a decimal fraction part of the accumulation result is performed to generate the pixel data of the image after the scale-up processing;
wherein, when the integer part of the reciprocal of the scale factor is “0” and the integer part of the accumulation result is “0”, product-sum calculation of pixel data updated previously and a coefficient corresponding to at least a part of the decimal fraction part of the accumulation result is performed without updating processing target pixel data to generate the pixel data of the image after the scale-up processing;
wherein, when the integer part of the reciprocal of the scale factor is not “0” and the integer part of the accumulation result is not “0”, the accumulation result is decremented; and
wherein, when the integer part of the reciprocal of the scale factor is not “0” and the integer part of the accumulation result is “0”, a value obtained by decrementing the reciprocal of the scale factor is added to the accumulation result, and product-sum calculation of processing target pixel data and a coefficient corresponding to at least a part of the decimal fraction part of the accumulation result is performed to generate the pixel data after the scale-down processing.

7. A display controller comprising:
a pixel data input interface to which pixel data of an input image is input;
a first scaler circuit which performs scale-up or scale-down processing of the input image input through the pixel data input interface;
a frame buffer which stores data processed by the first scaler circuit;
a second scaler circuit which performs the scale-up or scale-down processing of an image expressed by pixel data read from the frame buffer; and
an output interface which performs interface processing for outputting data processed by the second scaler circuit,
at least one of the first and second scaler circuits including:
a horizontal direction image processing section which performs the scale-up or scale-down processing for pixel data of an image arranged in a horizontal direction; and
a vertical direction image processing section which performs the scale-up or scale-down processing for pixel data of the image arranged in a vertical direction; and
at least one of the horizontal direction image processing section and the vertical direction image processing section including the image processing device as defined in claim 1.

8. A display controller comprising:
a pixel data input interface to which pixel data of an input image is input;
a first scaler circuit which performs scale-up or scale-down processing of the input image input through the pixel data input interface;
a frame buffer which stores data processed by the first scaler circuit;
a second scaler circuit which performs the scale-up or scale-down processing of an image expressed by pixel data read from the frame buffer; and
an output interface which performs interface processing for outputting data processed by the second scaler circuit,
at least one of the first and second scaler circuits including:
a horizontal direction image processing section which performs the scale-up or scale-down processing for pixel data of an image arranged in a horizontal direction; and
a vertical direction image processing section which performs the scale-up or scale-down processing for pixel data of the image arranged in a vertical direction; and
at least one of the horizontal direction image processing section and the vertical direction image processing section including the image processing device as defined in claim 2.

9. A display controller comprising:
a pixel data input interface to which pixel data of an input image is input;
a first scaler circuit which performs scale-up or scale-down processing of the input image input through the pixel data input interface;
a frame buffer which stores data processed by the first scaler circuit;
a second scaler circuit which performs the scale-up or scale-down processing of an image expressed by pixel data read from the frame buffer; and
an output interface which performs interface processing for outputting data processed by the second scaler circuit,
at least one of the first and second scaler circuits including:
a horizontal direction image processing section which performs the scale-up or scale-down processing for pixel data of an image arranged in a horizontal direction; and
a vertical direction image processing section which performs the scale-up or scale-down processing for pixel data of the image arranged in a vertical direction; and
at least one of the horizontal direction image processing section and the vertical direction image processing section including the image processing device as defined in claim 3.

10. An electronic instrument comprising:
a display panel;
the display controller as defined in claim 7; and
a display driver which drives the display panel based on pixel data supplied from the display controller.

11. An electronic instrument comprising:
a display panel;
the display controller as defined in claim 8; and
a display driver which drives the display panel based on pixel data supplied from the display controller.

12. An electronic instrument comprising:
a display panel;
the display controller as defined in claim 9; and
a display driver which drives the display panel based on pixel data supplied from the display controller.
